(19) United States
(12) Patent Application Publication
(10) Pub. No.: US 2015/0120722 A1
(43) Pub. Date: Apr. 30, 2015

(54) Method and system for providing multimedia content recommendations

(71) Applicant: TELEFONICA DIGITAL ESPANA, S.L.U., Madrid (ES)

(72) Inventors: Manuel MARTÍN MARTÍNEZ, MADRID (ES); Paulo VILLEGAS NÚÑEZ, MADRID (ES); Juan José ANDRÉS GUTIÉRREZ, MADRID (ES)

(73) Assignee: TELEFONICA DIGITAL ESPANA, S.L.U., Madrid (ES)

(21) Appl. No.: 14/068,562

(22) Filed: Oct. 31, 2013

(51) Int. Cl. G06F 17/30

(52) U.S. Cl. CPC G06F 17/30867
USPC 707/733

(57) ABSTRACT

A system for providing content recommendations, including a frontend manager for receiving explicit events from a client application of a user and generating implicit events based upon additional user actions within the client application; a backend storage of data on events and users and an Online Data Store for the explicit events and the implicit events; a Data Processor for creating an explicit user model from the explicit events and an implicit user model from the implicit events; a pool of recommendation engines with one or more recommendation algorithms for receiving the explicit user model and assigning a ranked recommendation list of content items to the user as a result, and further including an aggregator controlled by the Data Processor for aggregating the ranked recommendation lists based on a user-dependent strategy, in order to obtain multiple content recommendation lists of ranked items to be delivered by the frontend server to the client application in a final arrangement, pull from the Online Data Store along with data on the content sources.

### FIELD OF THE INVENTION

The present invention has its application within the telecommunication sector and, more particularly, relates to a method and system for providing recommendations of multimedia content to customers/users.

### BACKGROUND OF THE INVENTION

Nowadays there is a huge amount of multimedia content available and the need for recommendation, personalization and filtering is continuously growing. A recommendation system provides a specific type of filter that tries to show items according to user preferences.

In general terms, there are two basic types of recommendation techniques: content-based filtering and collaborative filtering. Content-based recommendation (CBR) methods examine items previously rated by the user. Collaborative filtering (CF) uses recommendations based on information about similar items or users. CBR relies on resources similarity, while CF relies on users' preferences and behavior.

Additionally, there is a technique somehow related to social discovery, called social recommendation, which uses propagation of activity within a defined social graph to push items of interests to users. Social discovery systems are described, for example, in US 2012/0221559 A1, where a social discovery platform (SDP) that transforms content seed selections and recommendations, via SDP components such as discovery and social influence, into events and discovery of other multimedia contents is disclosed. The SDP receives user selection of a universally resolvable content seed and queries a database using socially influenced content attributes associated with the universally resolvable content seed, in order to obtain a ranked list of universally resolvable content items from the query.

Social recommendation systems are being actively developed as a valuable alternative to standard Collaborative filtering techniques, since Social recommenders can offer access to novel items and their “web of trust” approach can increase user confidence. Reliability of information depends largely on the credibility of the sources from which they come. Social-based recommenders take into account two levels of social trust: the relationship between information supplier and receiver, and the reputation of the supplier within the community.

A number of techniques have also been developed to help combine the results of different recommendation engines into single results, an approach known as hybridization. Basically, there are three known hybridization designs for recommendation systems:
Monolithic exploiting different features: a single hybrid recommendation component combines several knowledge sources of different paradigms, E.g.: Ratings and user demographics or explicit requirements and needs used for similarity computation.
Parallel use of several systems: output of several existing implementations combined with some weighting scheme to get a global score.
Pipelined invocation of different systems: one recommender system pre-processes some input for the subsequent one.

However, hybridization by aggregating the results of different sources of recommendation (social recommendation, collaborative filtering, popularity lists, . . . ) into a single, homogeneous output list does not provide a meaningful way to present multiple recommendations to the user in an easy-to-grasp and effective fashion.

U.S. Pat. No. 8,260,787 is an example of an aggregator of different recommendation engines to provide that single unified list, including extracting reasons from each engine in the set to provide the end user and a normalization step. The outcome, however, is still one ordered list.

U.S. Pat. No. 8,250,012 also employs several recommenders, and switches from one to the other when providing recommendations. However, the final outcome comes from a single engine and the configuration of these recommenders serves a different purpose: to evaluate the relative performance of each recommender and therefore obtain a comparative metric for each one.

U.S. Pat. No. 8,122,020 Error! Reference source not found.proposes a system where users can tag heterogeneous items (e.g. of different nature, such as films, books, tickets or any element susceptible of being bought) and obtain recommendations based on such tags. Tagging activity of users may be either kept private or be public. In any case, tags allow users to create categories of items, and are feedback to the recommendation engine in order to provide similar items and fit the users' tastes. This system addresses a different problem: to collect and send back information from/to users and to associate items and tags (and similar tags) by offline processing of users' tagging activity.

WO 2013/033229 A1 constructs recommendations by weighting a plurality of ranked lists. However, upon aggregating preferences, the recommender fuses with all combined recommendations into a final single list and through this process the origin of each recommendation is lost.

US 2010/0241625 A1 decomposes user preferences into separate subsets according to statistical properties. The final effect is ordering a collection of items in terms of inferred user preferences, thus producing a composite ordered set. US 2010/0241625 A1 defines an incremental way of building a user profile based on expressed preferences by the user by learning a “signature” out of descriptive terms associated to those preferred items and their context, but it does not provide any aggregation of different data sources or of results from different recommendation algorithms.

EP2568395 discloses a method for automatic recommendations based on profile generation and a content retrieval unit. The method uses pre-calculated information but it is not a high performance and scalable system to end users since it is not focused in multiple information sources aggregation. Instead, it concentrates on aggregating the results of queries sent to different repositories, and on preloading user profiles based on social networks data. It is also quite centered on content-based recommendations, dealing extensively on text analysis techniques to resolve the queries sent to the repositories.

Summarizing, Hybrid recommendation systems usually aggregate inputs coming from different sources to generate a single recommendation list. This solution simplifies presentation of results, but it is too reductionist in terms of providing users with valuable insights to help them make up their decisions. Those hybrid recommendation systems that output a single list of results do not allow the user to differentiate adequately the source of recommendations (i.e.: why an item is recommended?). Moreover, collapsing the different sources into a single list provides the illusion of obtaining a simple preference ordering, while in practice the user mindset usually values recommendations in different dimensions.

Therefore, the user could not know how to get a better recommendation, whether by selecting other items or by modifying some of the ratings. Joining different types of results, e.g., CF recommenders based on similarity of tastes and Social recommenders based on signal propagation across a social graph, might incur into recommending irrelevant items to users, since taste similarity does not necessarily match the social graph. That is, the user cannot easily determine if an item is recommended “by friends” or “by similarity of tastes”, and the prioritization of one criteria over the other comes out as arbitrary. As a result, the overall ordering loses meaning and trust can be undermined.

Therefore, there is a need for an optimized combination of multiple recommendation sources so that the output results from the different recommendation sources can be synergistic without aggregating results in a single output list.

### SUMMARY OF THE INVENTION

The present invention solves the aforementioned problems by disclosing a method, system and computer program for combining synergistically multiple recommendation systems in real-time or with near real-time update of the recommendation lists generated by each of said multiple recommendation systems. Exploiting synergistically all the advantages of each source means a way so that each source can influence the others, which implies real-time or near real-time update and propagation of relevant information from each source after an user interaction with the recommendation system.

Instead of a single output recommendation list, the present invention provides each user with a real-time update of multiple recommendation lists which are generated combining the following principles:
pre-generation of the recommendation lists for all users running offline processes,
each recommendation source has its own update process, following its internal dynamics (changes in its input data or in the user's model that affect the output), but a final synchronization step ensures that coordination with the current state of the other sources is kept;
updated recommendation sources are pushed to client applications independently, making the update policy more effective (reacts instantaneously to changes) and more efficient (by providing partial updates, only changed information needs to be sent);
output recommendation lists are stored into both a fast-access in-memory database and the cache of the user's (mobile) device,
storage space and CPU needs are minimized by identifying users that actually need real-time update versus those who do not require it: the former, users requiring real-time update of recommendation lists, are the users who intensely use the client application using the recommendation service; the latter, users who are not intensive in requesting the recommendation service, do not require real-time update of their lists and their recommended sets can be computed on demand (when they connect to the recommendation service).

The present invention has its application to telecommunication networks, especially to Social networks which provide users with several mechanisms to recommend multimedia contents (e.g., webpages that have “Recommend”, “Share”, “Like”, “Buzz” action buttons for this purpose) to other users of the social network. Thus, the present invention allows direct social interaction with existing online communities such as FACEBOOK, MYSPACE, TWITTER and LINKEDIN, player add-ons that extend the capabilities of a client application in search, recommendation, sharing and discovery, and/or the like. It is also of application for media delivery services: in some possible network scenarios where the invention is applicable, the user has a user's device in which a client application can perform multimedia content downloading or streaming, and through which content discovery and recommendation is requested. Another application domain is that of e-commerce, for services which provide purchase suggestions to users based on past user actions, social buzz or friends' activities.

The present invention uses as input a selection of items from intelligent combination of several recommendation sources, including: popular or trending items, items acted upon by the user's contacts in a defined social graph, items selected from experts' choices and items proposed by a collaborative filtering (CF) or content-based recommendation (CBR) engine. All of the input items are ranked based on a defined user profile, and each ranked item (or each cluster of ranked items) defines an output recommendation list.

In the context of the invention, a source is defined as one origin of activity concerning items to be recommended, such as that it can be recorded and sent to the server to produce recommendation lists. Furthermore, each source has a high-level definition label that can be recognized by the user as an explanation for the origin of its recommendations. Examples of sources, with possible labels to be attached to them, are: activities of other users in the system (‘popular in users of the system’), a concrete recommendation engine based on user events (‘recommended based on your past preferences’), activities of other users in a defined social graph related to the user (‘your friends liked’) or activity in external social networks (‘currently trending items’) . . . . A user can request content items from a number of different available sources; i.e., each content item of a request is associated with one or more sources.

Items in the output recommendation lists of each source, according to a preferred embodiment of the invention, can be presented to the user through a “home screen” view (e.g., web-based browser interface) which displays a coordinated set of parallel ranked item lists, with information about their source and conveniently arranged. In other alternative embodiments, more advanced user's views than parallel coordinated lists are also possible, depending on the presentation/display capabilities of the user's device.

The final arrangement of ranked items, associated with information on their source, is the plurality of output recommendation lists presented to the user.

There is not a single unified ordering for all items, i.e., a single output list; there is a plurality of output lists and each list has its own internal ordering. This internal ordering is however consistent across all lists: it is always the estimated preference of each item for the user, as produced by an aggregated recommendation engine (whose formulation might be different for each user) applied separately to each list. Therefore, within each list, items are ordered by preference, but across lists, items are ordered (or better said, arranged) by semantically explainable criteria.

Item preference is also dynamically updated to increase freshness, by accumulating “impressions” from each rendering of an item in a list (preferably with a different base weight depending on the list) and letting that accumulated metric influence item selection.

The internal coherence of each list (all items in a list are explainable by homogenous criteria) facilitates assimilation of more items than in a single long list. Moreover, showing lists associated with those different sources of recommendations helps to convey justification of their presence to the user, thereby increasing trust and improving interaction.

Optionally, an additional step to maximize diversity across all lists at once can be performed to increase the perceived utility of the output lists for the end user. There are a number of procedures to increase diversity in a result set. A direct one is to create an augmented content set (increasing the size of each list), compute the internal set similarity (by estimating pairwise similarity of items within the set using e.g. a semantic or statistical criteria based on item metadata) and choosing the subset of the desired final size that maximizes that internal set similarity. Additional constraints may prioritize some lists over others when discarding items in the augmented set.

According to a first aspect of the present invention, a method of multimedia content recommendation is disclosed and comprises the following steps:
receiving, in a frontend server from a client application of a user,
   a request of content items from different available sources,
   and a set of explicit events, the set including
      events based upon rating by the user using the client application of at least one content item
      and additional events based upon explicit user actions within said client application (e.g., content purchases or reproductions);
generating, by the frontend server, an additional set of implicit events based upon additional user actions within said client application (e.g., navigation actions or information requests);
storing the explicit events and the implicit events in an online data store;
for each user in the frontend server, creating an explicit user model using all the explicit events and creating an implicit user model using all the implicit events;
sending all the explicit user models to a pool of recommendation engines, which comprises one or more recommendation algorithms (Alg₁, . . . , Alg_{N}), each recommendation algorithm, assigning a ranked recommendation list of content items from each said requested source to the user as a result;
storing the results from the recommendation algorithms in the online data store;
aggregating the ranked recommendation lists assigned to the user, in accordance with a configuration of the pool of recommendation engines based on a user-dependent strategy, in order to obtain a plurality of content recommendations comprising ranked items;
delivering a final arrangement of multiple content recommendation lists and information of the sources associated with each list in the final arrangement.

In a second aspect of the present invention, a content recommender system is provided in a communication network (e.g. a wireless communication network), wherein a request of content items from one or more available sources is received from a user, the system comprising:
a frontend server, which comprises one or more frontend managers for receiving a set of explicit events from a client application of the user;
   the set of explicit events including:
      events based upon ratings on the content items performed by the user using the client application,
      additional events based upon explicit user actions within said client application,
   the frontend server being also in charge of generating an additional set of implicit events based upon additional user actions within said client application;
a backend storage, connected to the frontend server, which stores data on events and users;
an Online Data Store, connected to the frontend server, which stores the explicit events and the implicit events;
a Data Processor for creating an explicit user model using all the explicit events and creating an implicit user model using all the implicit events, and for storing the created explicit user model and the implicit user model in the Online Data Store, retrieving data on events and users from online data store and storing the retrieved data in the backend storage;
a pool of recommendation engines connected to the Online Data Store for receiving the explicit user model and comprising:
   one or more recommendation algorithms for assigning a ranked recommendation list of content items to the user as a result,
   and further comprising an aggregator, controlled by the Data Processor, for aggregating the ranked recommendation lists assigned to the user by each recommendation algorithm, in accordance with a configuration of the pool of recommendation engines based on a user-dependent strategy.

From the pool of recommendation engines, the system obtains multiple content recommendation lists comprising ranked items and these content recommendations are delivered by the frontend server to the client application in a final arrangement, which is pull from the Online Data Store along with data on the sources associated with the ranked items of the final arrangement.

In a third aspect of the present invention, a computer program is disclosed, comprising computer program code means adapted to perform the steps of the described method when said program is run on a computer, a digital signal processor, a field-programmable gate array, an application-specific integrated circuit, a micro-processor, a micro-controller, or any other form of programmable hardware. A digital data storage medium is also provided for storing a computer program which comprises instructions causing a computer executing the program to perform the above-described method.

The method and system in accordance with the above described aspects of the invention have a number of advantages with respect to prior art, summarized as follows:
Efficient incremental model updates: one of the classic problems in recommender systems is the opposition between fast updates (which lets the system react swiftly to the latest user events) and batch processing (much more efficient in terms of computational and network loads). The proposed invention achieves the best compromise.
Efficient information update, with reduced network load. The server processes events in short batches, and updates user models only for the users that warrant it. Updated user model or background information can result in modified recommendations for some list types. So the client caches recommended items by list type; upon connection the system sends specialized updates that contain only the recommendation lists that are different to the ones the client cache already have.
The present invention solves the “cold start” problem: new users have the possibility to fully interact since the beginning thanks to a friendly touchdown where basic user preferences are fetched, integration with popular social networks (e.g. Facebook and Twitter) and an alternative expert users' database. Thus, new users always have content in their home screen and other users to interact with. Of course, this information can be more personalized as users interact with the system (i.e. the system knows the user better).
Seamless blend of generic and personalized results: the present invention uses both generic sources (coming from aggregate signals) as well as sources tuned to the user profile. Engine aggregation and the presentation of different sources to the user ensures a smooth transition from one to the other as the user profile gets filled, so that output can be consistent and valid at all times.
Better and more diverse explanations. The aggregation of different recommenders and the use of different sources of events leading up to recommendations enable the invention to come up with much more improved explanations to the user of the generated recommendations. Explanations within a list can be related to homogeneous criteria, and between lists to complementary criteria. This increases understanding and explanatory power at the same time.
Higher diversity in results. For the same reason (coordinated integration of different sources) the recommendations results are more diverse and enable better discovery of new, unexpected items. An explicit additional step across lists increases actual and perceived diversity, which helps a better exploitation of the item space and increases the utility of user interface ‘real space’.
Perfect blending of social signals with profile matching: the use of friends' events as a source of recommendations, but moderated through evaluation of items by the recommendation pool, brings in the most relevant social data to the user.
Increased freshness and adaptation: performing time-based damping of results and correlating with users' exposure to items as the invention does ensure that proposed items do not stall and they get adapted to users' interest shifts.
The present invention leads to a real-life scenario were all users (regardless their level of use of the application) perceive their information up-to-date with the minimum resources spent in the back-end, where the information is generated and maintained.
The present invention allows the isolation of system components (online data storage, recommendation engine, data processor and backend). This feature allows scalability without loss of performance. Furthermore, it is possible to spin up a parallel node and balance requests using a load balancer, without any other service layer having an idea that this is being done, and maintaining all data in memory without consistency problems.
High performance: the proposed system is divided into several efficient modules that can be tuned to increase its individual performance. Besides, as a general guideline, heavy processes are run offline and their results are stored in a fast-access location (e.g. host RAM memory, memory database) in order to be rapidly provided when another module requests them.
Scalable system: separation into modules (pointed above) allows increasing the overall capacity by increasing each module's capacity, which makes scalability a natural feature. Each module might run in a different host and keep communicating with the others thanks to the REST interface it is wrapped with.
Highly configurable: apart from general system configuration, each module can be configured by setting many parameters values to tune its behavior.
A large amount of information is always available, both for final users (through the mobile application) and to be exchanged among different modules. This is possible thanks to a combination of backend long-term storage and online data store that acts like a fast-access buffer for data exchange.
Variety of recommendation techniques available: a pool of different recommendation engines might be available (if configured so). These engines can be hybridized (combined) to provide more personalized recommendations. Besides, different strategies can be applied in order to provide even more personalized results, to the extent that each user may have its own strategy if desired.
Highly personalized recommendations: as pointed before, regardless of the overall strategy used to provide recommendations, each user might be assigned a different strategy to be provided with recommendations. This means reaching a higher level of personalization: assuming users are recommended items based on their activity as usual, the technique used to recommend such items also depends on the user's activity.

These and other advantages will be apparent in the light of the detailed description of the invention.

### DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows a schematic diagram of a generic user interface of a client application, as known in prior art, running in a user's device which uses a system for content recommendation, in accordance with a possible application of the present invention.

FIG. 2 presents a block diagram of the system architecture for content recommendation, in accordance with a preferred embodiment of the invention.

FIG. 3 shows a data flow for user interaction, event extraction and storage in the system of FIG. 2, according to a possible embodiment of the invention.

FIG. 4 shows a data flow for creation and update of user models in the system of FIG. 2, according to another possible embodiment of the invention.

FIG. 5 shows a data flow for generation and aggregation of recommendation lists in the system of FIG. 2, according to another possible embodiment of the invention.

FIG. 6 shows a graphical diagram of the time effect on the events accumulated in the system for content recommendation, according to a possible embodiment of the invention.

FIG. 7 shows a data flow for delivery and update of recommendation lists in the system of FIG. 2, according to another possible embodiment of the invention.

FIG. 8 presents a block diagram of the system architecture for content recommendation, according to a further possible embodiment of the invention in a distributed computer network.

### DETAILED DESCRIPTION

The matters defined in this detailed description are provided to assist in a comprehensive understanding of the invention. Accordingly, those of ordinary skill in the art will recognize that variation changes and modifications of the embodiments described herein can be made without departing from the scope and spirit of the invention. Also, description of well-known functions and elements are omitted for clarity and conciseness.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

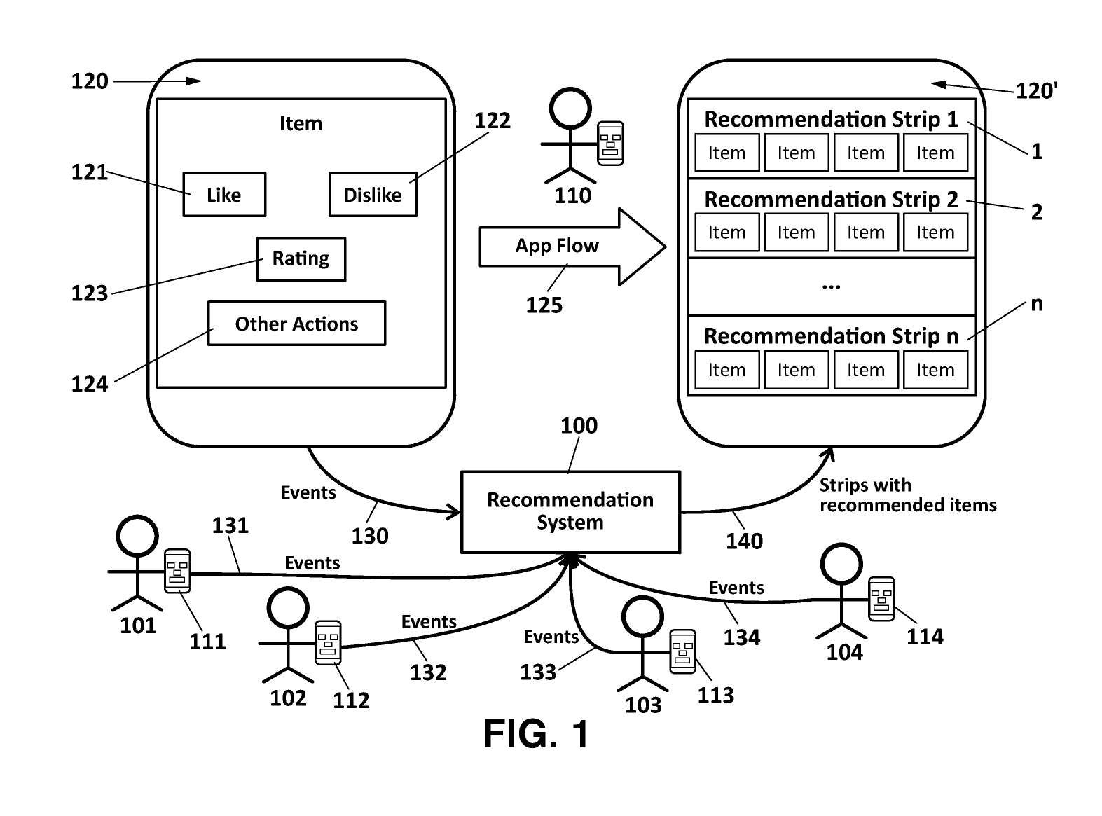

It is within this context, that various embodiments of the invention are now presented with reference to the FIGS. 1-8.

Note that in this text, the term “comprises” and its derivations (such as “comprising”, etc.) should not be understood in an excluding sense, that is, these terms should not be interpreted as excluding the possibility that what is described and defined may include further elements, steps, etc.

FIG. 1 presents multiple consumers or users (101, 102, 103, 104, 110) with access to vast libraries of content items, e.g., music, video, documents, . . . , which may be accessed through a client application running a user's device (111, 112, 113, 114), e.g., a mobile terminal, and viewed on an electronic display of the user's device (111, 112, 113, 114) by means of a GUI or graphical user interface (120). Typically, the client application enables the user (101, 102, 103, 104, 110) to rate a number of items by means of specific action buttons (121, 122, 123, 124) provided by the graphical user interface (120) for performing like, dislike, rating or other actions than can be used by a recommender (100) to generate useful personalized recommendations. The users (101, 102, 103, 104, 110) generate events (130, 131, 132, 133, 134) while interacting with the client application on his/her mobile device. Those events (130, 131, 132, 133, 134) are used to create and update user models, which profile the user preferences for items in the recommender (100). FIG. 1 shows the user interface (120) before a user makes some actions that eventually generate events (130). For example, a user (110) can generate events (130) in different ways, without intention to be exclusive, by expressing “like” action (121), expressing “dislike” action (122), rating an item (123) or other actions (124) which could generate events (130). The recommender (100) gathers all generated events (130, 131, 132, 133, 134) from users (101, 102, 103, 104, 110) and outputs (140) updated recommendation strips (1, 2, . . . , n) on the basis of all gathered information and using the proper recommendation algorithm for each case. The output recommendation strips (1, 2, . . . , n) are delivered to the event generating user (110) and displayed (120′) in the user's device. The data flow (125), followed by the user (110) of the client application, goes from the events (130) produced by the user (110) to the generated lists of recommendation strips (1, 2, . . . , n), and iterates continuously across both types of activity: generating input events and generating output recommendation lists.

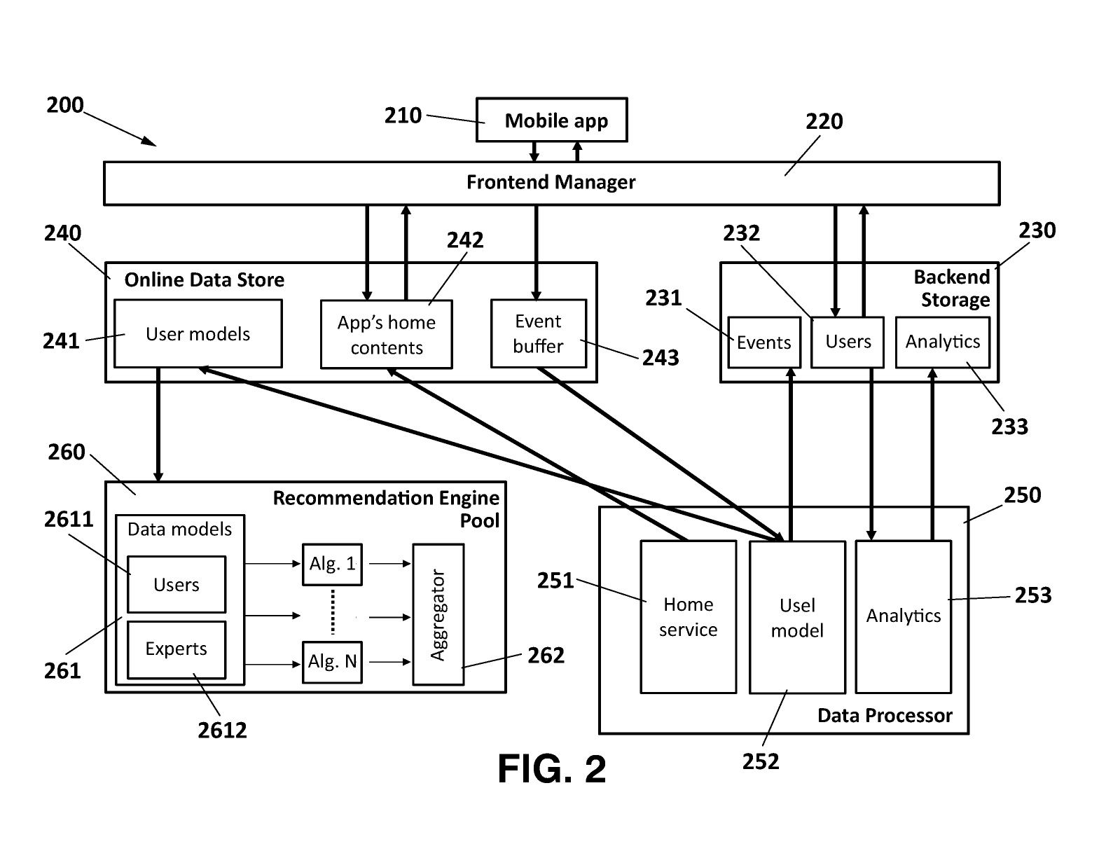

FIG. 2 shows the block architecture of a recommender system (200) for providing content recommendations in accordance with a possible embodiment. Users generating events interacts with the recommender system (200) by means of a client application (210) in the user's device through a front-end manager (220) of the recommender system (200), which in turn comprises a backend storage (220) for storing data on events (231), users (232) generating events and analytics (233) on the generation of events. Also, the recommender system (200) comprises an Online Data Store (240), which is an online component holding all the live information for the system: user models (241), the contents of the application (242) and an event buffer (243) with all the generated events. The recommender system (200) further comprises a Pool of recommendation engines (260) and a Data Processor (250) in charge of the creation of user models, and the feed and aggregation of the recommendation engines in the pool. The Data Processor (250) module includes the following submodules: Home service (251) which generates contents for the client application and adds processing steps of incorporating implicit feedback and time-dampening effects, User model (252) which holds information inferred from the users' activity, and Analytics submodule (253) which computes metrics and all the information that could be useful for management tasks. The Pool of recommendation engines (260) comprises a plurality of recommenders executing given recommendation algorithms (Alg₁, . . . , Alg_{N}) under a determined configuration. In a preferred embodiment, these recommenders use recommendation algorithms (Alg₁, . . . , Alg_{N}) based on traditional Collaborative Filtering or CF algorithms. Each recommender of the CF-based recommendation engine pool can be configured in different ways, as described below:
Single algorithm: the same CF algorithm is used for all users. Usual recommendation techniques are (all of them could be used but they are not the only available ones):
   User-based algorithms: the basic idea is the similarity between pairs of users who have both rated the same items. Such similarity can be computed and expressed using e.g. the following methods:
      Correlations (Pearson, Spearman, Cosine, Uncentered Cosine, etc.).
      Euclidean Distance.
      City Block Distance.
      Tanimoto Coefficient.
      Log Likelihood.
   Item-based algorithms: the basic idea is the similarity between pairs of items that have both been rated by the same users. Such similarity can be computed as pointed above.
   TopRated N: items with the highest average rating.
   Singular Value Decomposition (SVD).
   K Nearest Neighbors (KNN).
   Wisdom of the Few (WOTF)Error! Reference source not found.: this algorithm is a special case of KNN. It deserves a special mention because its main idea is to apply a nearest neighbor algorithm over a user model with expert opinions, aiming at:
      Increasing recommendation accuracy by means of reducing noise usually present in normal users' explicit feedback.
      Minimizing the “cold start” problem: difficulties to provide personalized recommendations when the users' data model still contains little data.
Algorithm aggregation: linear combination of multiple CF algorithms. First, a set of algorithms is chosen assigning a weight (between 0 and 1) to each algorithm of the set; the final score of each item is the weighted sum of each algorithm's score.
   Being sᵢ the score for a certain item yielded by algorithm i (out of a total number of algorithms N) and wᵢ the weight applied to the algorithm i, the final score S is computed as follows:

$$S = {\sum }_{i = 1}^{N} {ω}_{i} {s}_{i}$$

User-personalized algorithm: each user is assigned a different algorithm or strategy (either single or aggregated) aiming at providing even more personalized recommendations. This strategy is dynamically updated, so that the exact aggregation can evolve depending on the user's history with the system (for instance, the strategy for recent users gives more weight to some algorithms, as users keep providing feedback the weights get updated to change priority to other algorithms in the set).

The Pool of recommendation engines (260) applies the recommendation algorithms (Alg₁, . . . , Alg_{N}), following the selected configuration of the pool, to data models (261) comprising User and Expert preferences (2611, 2612), stored in memory in order to grant a fast access, and final results from the recommendation algorithms (Alg₁, . . . , Alg_{N}) are combined by an aggregator (262) according to a chosen strategy, if any. User preferences (2611) are those belonging to the computed explicit data models, while expert preferences (2612) are those of special data models computed from external experts' ratings on items available in the service.

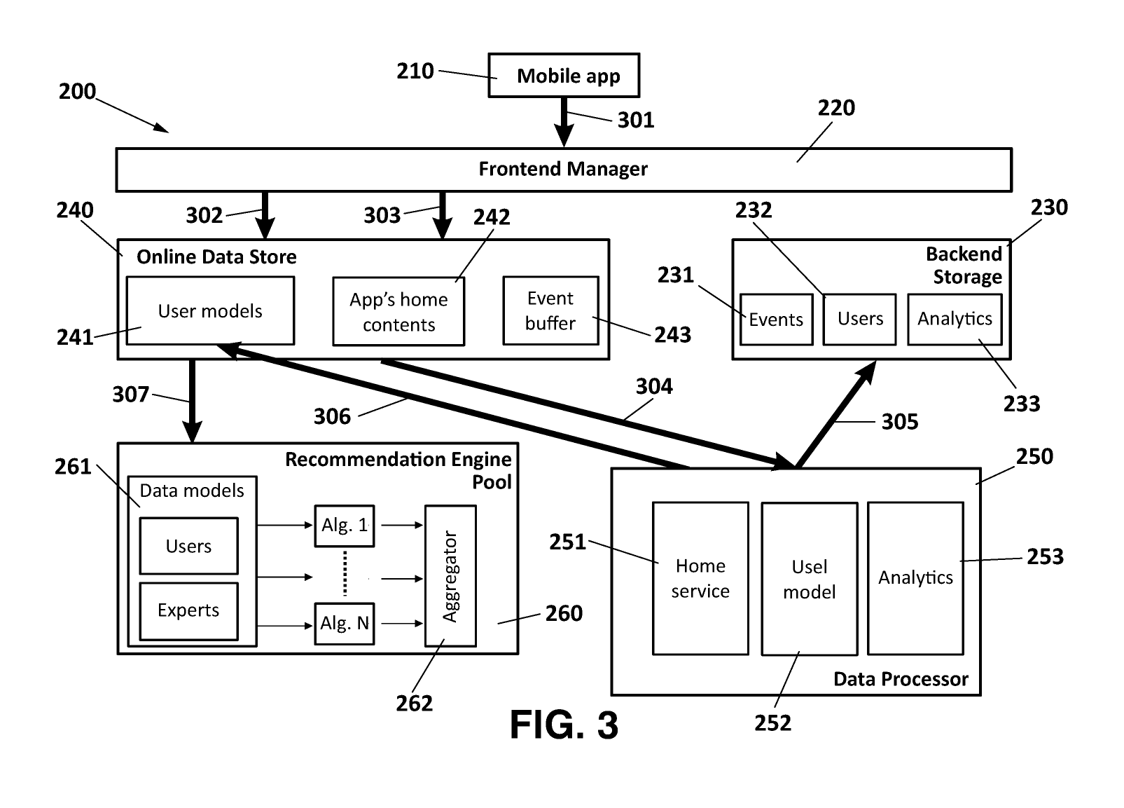

FIG. 3 shows the operational flow of the interaction between the user and the system (200), comprising the following stages:

The user interacts with the system (200) through the client application (210) on his/her mobile device and generates events (301) using this client application (210). These events are sent to the Frontend manager (220), where they are processed and stored. Events can be explicit, e.g., like ratings: “I like it” or “I do not like it”, and others are implicit events, automatically generated by the Frontend manager (220), at the server side, such as browsing items in navigation menus. The events are used to create and update user models, which profile the user preferences for items in the service. For any given user two different models are created, called “explicit” and “implicit”. Explicit user models are sent to the pool of recommendation engines (260), whose recommendation algorithms (Alg₁, . . . , Alg_{N}) are based on collaborative filtering. The system (200) then requests a recommendation, a Top-N ranked list, for each user of interest, and aggregates the result across all the recommendation algorithms (Alg₁, . . . , Alg_{N}).

Frontend manager (220) gathers (302) every explicit event, validates each event and stores in the online data store (240).

Frontend manager (220) analyzes (303) all the gathered explicit events and, on the other hand, generates implicit events from all the requests received from the client application (210). Then, the frontend manager stores them in the online data store (240), as in the previous stage. Frontend Manager (220) pulls ranked lists from the Online Data Store (240) to show the user when relevant.

Recommendations are stored as one source of items to discover in the online data store (240). Other data sources are: activity of user contacts, “friends”, and overall signals “trending” or “popular”. All of them end up in the online data store (240). Data processor (250) is in charge of obtaining data (304), including events generated at either the client side or the server side, from online data store (240).

Then, Data processor (250) stores the retrieved data (305) in the backend storage (230). Backend processing is thus decoupled from online activity, highly improving performance.

Data processor (250) also processes all stored events and this processing implies the generation of the user models (306). The pool of recommendation engines (260) reads the processed events (307) from online data store (240).

Data in the online data store (240) is organized in different strips depending on the meaning. Depending on the recommendation algorithms (Alg₁, . . . , Alg_{N}) applied, the information is shortened in different ways for each strip. Without intention to be exclusive, a preferred embodiment of the invention may include the following strips:
“For me” strip: Personal recommendations based on matching the user's profile through the aggregated recommendation system.
“Friends” Activity: Recommendations based on user's friends activity and sorted according user's profile.
“Trending”: Recommendations based on what is “hot” (most recommended, most rated, etc.) in a precise moment and sorted according to user's profile.
Others.

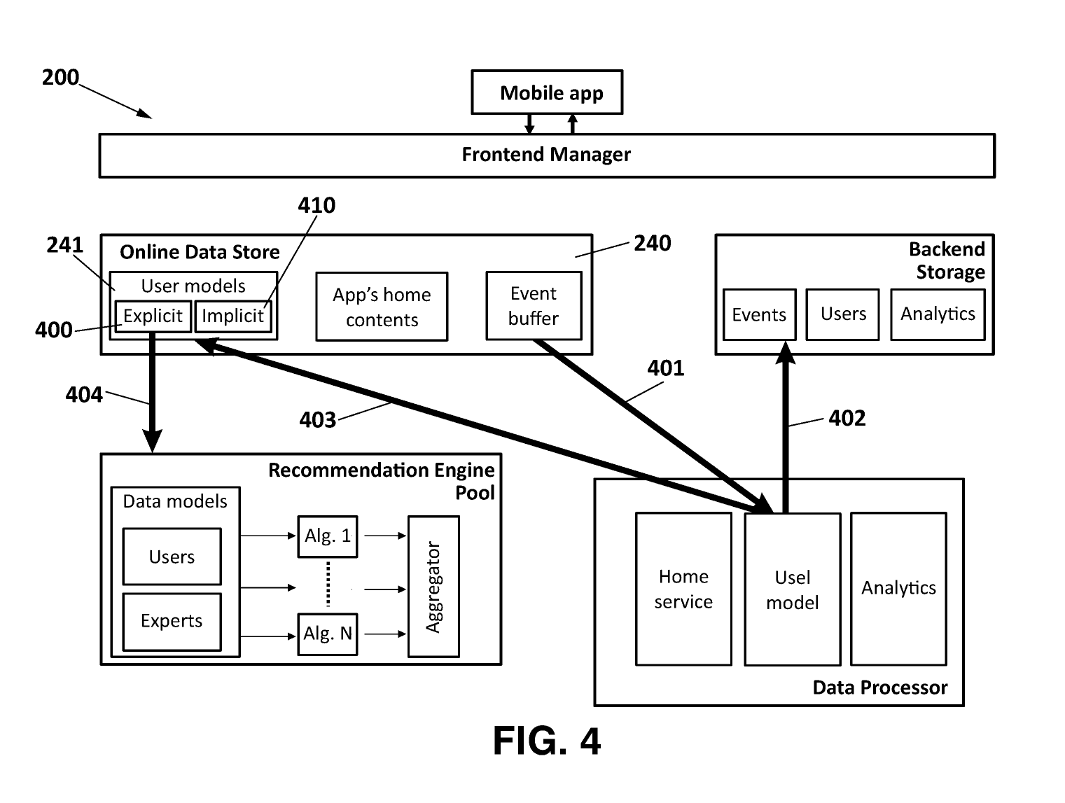

Two different user models are generated: “explicit” based on ratings and an “implicit” model. The generation of these models are explained in FIG. 4. User explicit events coming from the client application (210) are processed to create user preference models. Frontend manager (220) analyzes the explicit events and also generates implicit events from all the requests received from the client application (210). Data processor (250) retrieves (401) events from an event buffer (243) where they are stored in the online data store (240). Data processor (250) stores (402) the retrieved events (231), which are being processed, in the backend storage (230) in order to decouple processing from online activity.

For a given user two different models are created: explicit model (400) indicating stable preferences, mostly composed of user decisions, and implicit model (410) indicating transient preferences, mostly extracted from user navigation.

In general terms, each event is a tuple of the form:
timestamp, user, item, event-type, event-value, context
   where:
timestamp marks the moment in which the event was generated by the user
user is an identifier ID uniquely identifying the user who generated the event (The ID might also refer to a group of users for collective uses in which it is not possible discriminate beyond e.g. members in a household)
item uniquely identifies the item the event relates to (the user can also generate events which do not refer to any particular item, these are in principle not used for preference profiling. In more elaborate schemas they may also provide preference profiling, if there is a method to relate those events to particular items or groups of items)
event-type expresses the class of event generated, from a previously determined taxonomy coming from the service functionality. Some of them will be catalogued as explicit and some as implicit events.
event-value expresses the captured value of the event; possible range of values depend on event type. E.g. it might be a numeric value in the 1-5 scale for a rating event, or a string for a search event.
context expresses the definition of the characteristics for the environment surrounding the event generation. It might serve as the basis for contextual recommendations, and can take many forms.

The method is flexible enough to accommodate any combination from explicit and implicit user events. The event value can be expressed in many different shapes and scales depending on the event type: unary, nominal/categorical, ordinal, interval or ratio scales. In order to be able to combine different event types, it is convenient for all of them to be mapped to a numerical preference score on a normalized scale. This mapping can depend on all the mentioned event tuple components.

For practical computation purposes it is convenient that the final preference scale is a signed scale, in which there is a neutral element that corresponds to a “neutral preference” for the item (i.e. indifference from the user's point of view). For instance, in a scale from −5 to 5 the 0 point would be the neutral preference; in a 0 to 10 scale the neutral element would be 5 an asymmetrical signed scale can also be used, in which the negative range and the positive range are not equal). Preferences above the neutral element are positive preferences i.e. express a positive interest from the user. Preferences below the neutral element express a negative opinion by the user.

The combination of the preferences from all events generated by a user on a given item creates the preference value for that (item, user) pair. This means that the final user model can be formed by triples
user, item, preference

Such aggregation can take different shapes:
Weighted sum: the final preference sums all individual preferences generated for that item, weighted by a score which depends on the event type.
Time-dampened weighted sum: similar to the previous one, but the weight for each event is multiplied by a dampening factor that depends on the event age, so that older events count less than newer events (implicitly acknowledging taste evolution from the user).
Extreme: only the highest or lowest preference value (the one furthest from the neutral preference) is used
Latest: only the latest event generated for a given item is used
Dampened reinforcement: the first event for a given item sets the initial value; all subsequent events on that item modify that value upwards or downwards, with each new event having less effect than the previous one.

In an embodiment of the invention, a discrimination between explicit and implicit event types is performed so that they lead to the creation (403) of explicit and implicit models (400, 410), follow separate aggregation paths when applied (404) to the pool of recommendation engines (260) and come up with a final preference value for each path. This means that the final user model contains tuples of the form:
user, item, explicit-preference, implicit-preference

For the computation of explicit-preference, in which user's taste could be thought of being better defined by single actions, extreme or latest aggregations are used typically, while for implicit-preference, in which what counts is the overall user behavior, weighted sums or time-dampened weighted sums are used normally. But the exact formula used depends on the application scenario and each use case.

User models (241) are updated at periodic intervals, in an incremental fashion: the system (200) only regenerates models for users who have had enough activity in the period, so as to potentially affect their model.

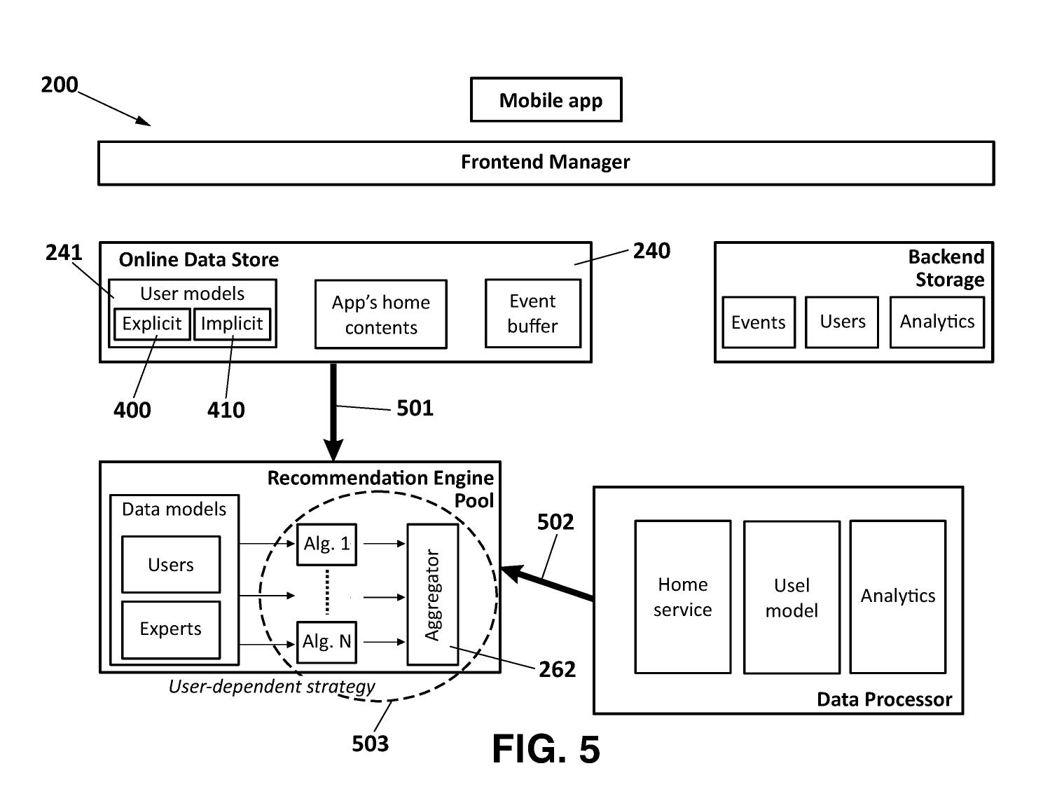

The user explicit model (400) described before is the data source to provide recommendations. Users' preferences, i.e. content ratings, are loaded into memory and processed by the CF-based pool of recommendation engines (260) to provide such recommended items when requested, following the operational flow shown in FIG. 5.

The pool of recommendation engines (260) periodically fetches the user preferences (501) from the explicit model (400) and incorporates them into its memory data model (typically a matrix whose elements are the ratings assigned by each user—rows—to each item—columns—). The similarities between the elements (usually items) involved in the current update process and the rest of elements are immediately calculated and saved into memory. This way, they can be quickly accessed for each recommendation request instead of computing them per request.

When a recommendation request arrives (502) from the data processor (250), the pool of recommendation engines (260) applies the corresponding recommendation technique determined by the configuration of algorithms (Alg₁, . . . , Alg_{N}) and the aggregator (262) based on a user-dependent strategy (503) and returns the result.

With the pool of recommendation engines (260) updated with the most recent explicit models coming from event processing, and the implicit models also in place, the system (200) can proceed to re-create the different ranked lists of items that are to be delivered to the end user. The exact range and characteristics of those ranked lists depends on service considerations. As aforementioned, only the lists whose data sources have changed are updated; the rest are kept as they were. The ranked lists can come from different sources and have different shapes but all of them share one common characteristic: they are personalized for the concrete user to whom they are delivered.

This personalization comes in different flavors:
i) Because they are generated as recommendation lists provided by the available engine, based in the user profile.
ii) Because they are generated by the activity of other users signaled as “followed” by the current user. This can be done explicitly by the user (defining as a result a social graph on the service), or automatically by the system, based on demographic, statistical or similarity considerations.
iii) Because they come from general ‘trending’ lists (computed by the front-end manager based on available internal or external data) that are however customized to reflect categories or catalogues to which the user is subscribed

The first type of list i) comes intrinsically ordered by user preference, as it is generated by the pool of recommendation engines (260). The other two, ii) and iii), do not, so in order to provide further personalization, the Data Processor (250) modifies those lists by asking the pool of recommendation engines (260) to provide a preference estimation for each item in the list, which is a weighted aggregation of the preference estimation provided by each of the recommendation algorithms (Alg1, . . . , AlgN), including the algorithm based on user preferences (2611) and the one based on expert preferences (2612). In other words, this part uses the pool of recommendation engines (260) as a Ranking Engine; in the final result the set of items comes from an external source, but their order is set by the pool of recommendation engines (260).

Each computed list, once all reordering algorithms have been applied, is pruned to the size determined by GUI constraints of the user's device, to generate the final sets to be exposed to the user.

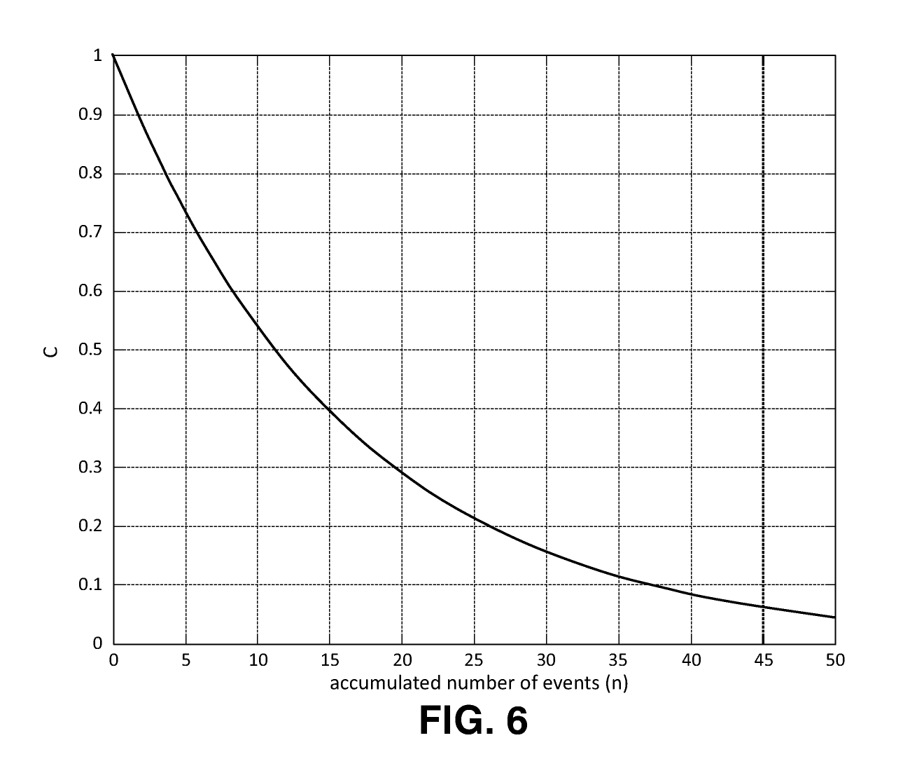

Two additional processing steps can be carried out for each list:
Incorporation of implicit feedback models, which in an additive fashion modify the preference value for each item to include transient interests gathered from the user events. This includes also adding negative interest computed by observing the user's lack of activity on repeated exposure to certain items.
A time-dependent dampening ensuring that, for lists whose update process is continuous (such as events stemming from friends activity) information, remains ‘fresh’. This is done by an additional weighting of each score by event time. Note that this is especially needed for items coming from events generated by contacts (friends), given that the event timestamp does not correspond to the current user's timeline but to the contact timeline, and has therefore not being taken into account when generating the user's preference for the item. FIG. 6 shows an example embodiment.

The time dampening effect can be modeled as an exponential function decreasing with time, i.e. something akin to

wₘ=w·e^{-kt}

where wₘ is the modified weight for the item as a function of the time t elapsed since the event/recommendation was produced, and k is a constant managing the dampening effect.

However in practical terms an embodiment might substitute linear time for the number of accumulated events, as shown in FIG. 6, somehow assuming that events are more or less equally spaced in time (something not true in practice but true enough so that it does not introduce distortion).

Hence, wₘ=w·e^{-Kn}
where n is the number of events experienced since that item was produced.

In order to ease efficiency, the modified weight wₘ may be expressed as:

wₘ=w·Cⁿ

with C=e^{-K}. This can be very efficiently computed by the Data Processor (250) as follows: each time a new item is added to a time-based list (such as the items coming from the friend's timeline), just multiply the existing item scores by C. The net results is that old items will get pushed below in the ranked list (depending on their initial score, it will take more or less time for them to disappear from the list).

FIG. 6 shows an example of the effect in the final effective weight for each item score of the aggregated multiplying constant C as the number n of accumulated events grows. As it can be seen, the initial value when the event for this item is received (1, i.e. full weight) gets reduced to a 5% of the initial weight (0.05) after about 50 events. The exact weight adjustment depends on the constant chosen,

Diversity is one of the features most appreciated by users, since it increases their capacity of choice and provides a better exploration of the item space. So a recommender should strive for diversity, even at the expense of some loss of accuracy.

Generation of item lists from different sources ensures injection of that diversity in the final sets. However the re-ranking of the lists described before, while necessary to achieve the desired personalization to user's interests, can reduce somehow the perceived diversity. For that reason, according to an alternative embodiment, an additional (optional) step can be added, which helps balance the compromise between personalization (i.e. match to user's preferences) and diversity (i.e. maximization of item space coverage).

The process is as follows:
1. The size of the lists composed in the previous subsection is increased over the requirements imposed by the user interface, so that for each lists there are more items available than places in the final GUI.
2. A metric f of within-group diversity contribution is computed for each item in every list. That is, for each item a figure is obtained that expresses how much does it contribute to the overall diversity across all lists.
3. The score for each item is temporarily updated to add an scaled version of that diversity metric f (the scale factor depends on the desired compromise between diversity and accuracy)
4. Lists are reordered by the new score, and then the lists are pruned to the GUI final size. Lists are also consolidated by eliminating duplicates between them, following a predetermined priority order.
5. Scores are restored to their original values, and lists are reordered back to their user preference strict order.

The overall result is that, potentially, the final item set gains additional items that, strictly speaking, come later in order of user preference than the original ones, but increase substantially the perceived diversity. Note that the process is done for all lists at once, so diversity is maximized as a whole; this lets one list influence the composition of other lists by affecting their diversity metrics. Each final list is reordered by user preference to keep consistency in a single criterion for layout and facilitate user understanding of the results.

The diversity metric used strives to maximize the mutual information between all items in the list, and as a consequence helps to increase coverage of the item space in the final superset offered to the user. A number of metrics are possible for this task, e.g., the ones described by N. Hurley and M. Zhang, “Novelty and diversity in Top-N recommendation—analysis and evaluation,” ACM Trans. Internet Technol., vol. 10, no. 4, March 2011.

The exact amount of extra items in each lists used for this step is a compromise between the desire for diversity and computational complexity (since diversity is a composite metric among all items in a set, its complexity increases quadratically with the number of items).

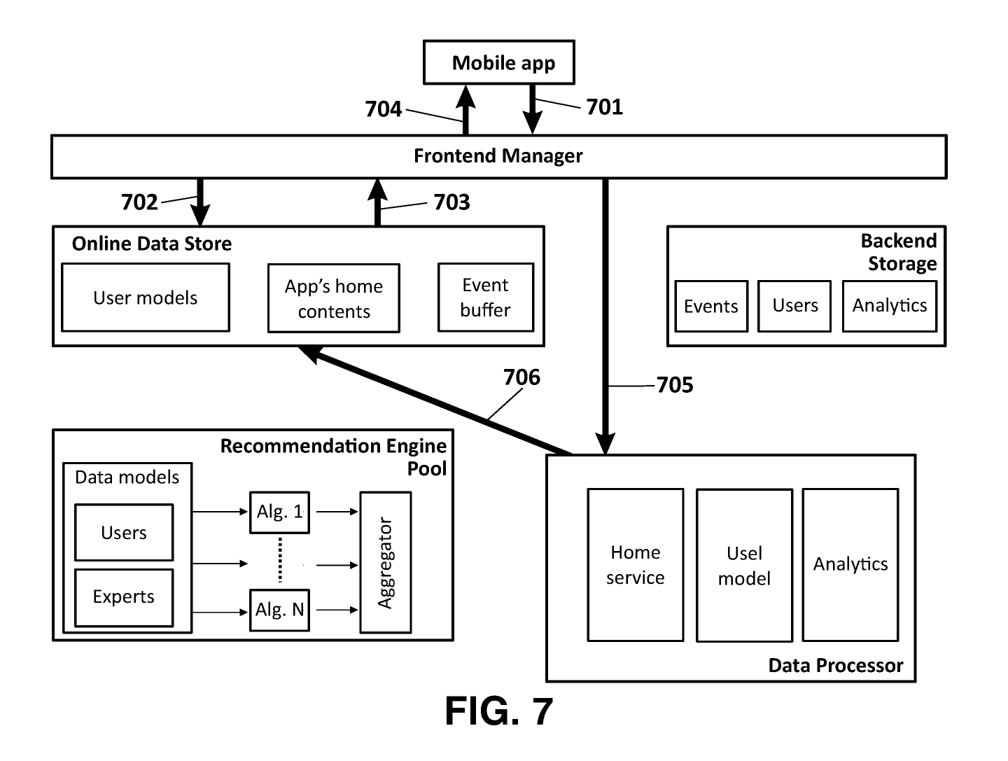

FIG. 7 shows the operational flow of delivery and update of the final lists by the system (200) to the end user. When user wants to use the client application (210), sends a request to frontend manager (220) to get the needed information. Frontend manager (220) is responsible of delivering it to the client application (210). User opens the client application (210) and then the client application (210) requests the needed information (701) to the frontend manager (220). Then, the frontend manager (220) pulls ranked lists from the online data storage (240) to show the user when relevant. For this goal, the frontend manager (220) accesses (702) to the online data store (240) and retrieves the requested information, which is previously calculated and stored into that system (200). The online data store (240) provides the frontend manager (220) with the requested information (703). This information is delivered (704) to the client application (210). In case the requested information is not available, the frontend manager (220) requests such information (705) to the Data Processor (250), which is in charge of calculating and providing it, the same way it is previously explained. Data Processor stores (706) this information in the online data store (240).

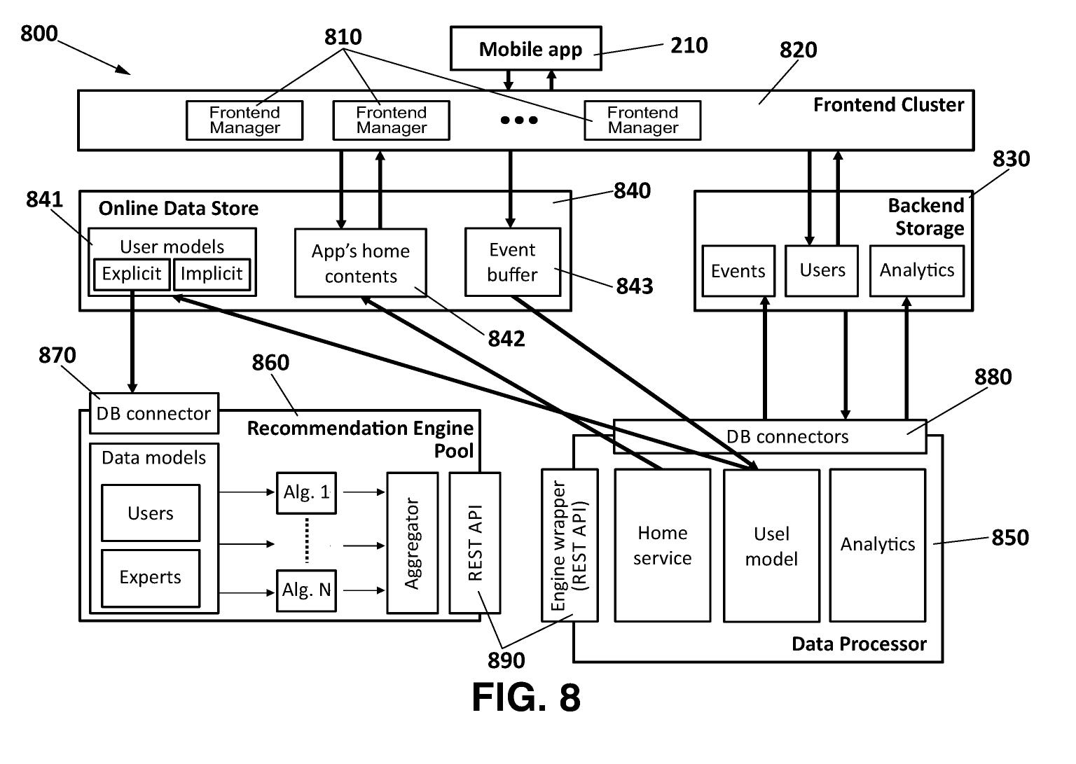

Regarding the aforementioned compromise between the desire for diversity and computational complexity, FIG. 8 shows an embodiment of the invention which eases the burden in the list of items by performing pre-materialization of the final lists, moving the load of the task offline and therefore increasing online performance and throughput. A system (800) for providing content recommendations can be implemented via a distributed computer network embodiment comprising a client application (210) running in a user's device and a plurality of front-end server components (810) forming a front-end cluster (820) with optimized data flow for increased performance. This cluster (820) of front-end servers or managers (810) provides content to the client application (210) and sends usage information to the back-end ecosystem. The Online Data Store (840) stores users' information, such as user preferences for item (841), contents of the home page (842) of the client application (210) and the new events in an event buffer (843). The backend storage (830) stores the data (305) retrieved by the Data processor (850). The system (800) uses dynamic pre-materialization of the selected items to achieve high performance, caching views of the items-selection at the server side, so that they can be immediately available when the user accesses the client application (210). The system (800) comprises a Relational Database that stores information about user accounts, events (all events) and analytical data related to the app usage, etc. This Relational Database, through database connectors (870, 880) shares the information stored in the Online Data Store (840) and the backend storage (830) with the pool of recommendation engines (860) and the data processor (850) respectively. Client-side caching is also applied to compensate for possible network glitches and for network efficiency. The front-end cluster (820) assumes that the caching takes place, and as mentioned, upon connection, the front-end cluster (820) is the entity in charge of sending to the client application (210) only the item lists that differ significantly from what the client application (210) has already got. The front-end cluster (820) can associate unique identifiers to item lists to ease matching and checking of cached lists. Update policies for the pre-materialized views follow distinct paths, immediate or periodic, depending on the source of the possible change, to achieve the optimum compromise between freshness and efficiency.

A notification subsystem allows also the backend server or backend storage (830) to also push specific recommendations to users in real-time, when deemed significant for any reason (e.g. because they have immediate interest). The CF-based pool of recommendation engines (860) can be single- or multiple-node highly configurable, implementing different recommendation algorithms (Alg₁, . . . , Alg_{N}), techniques and strategies in order to provide the best personalized recommendations to users. User preferences are stored in memory in order to grant a fast access, and final results are aggregated according to the chosen strategy, if any, by the aggregator (862). An application program interface or API (890) provides access to the recommendation engine pool. This API (890) comprises a set of functions that encapsulates the functionality and capacities of the pool of recommendation engines (860). This API (890) can be implemented using a REST approach (but not exclusively; it can be implemented using other different technologies and approaches) that specifies how to interact with the recommendation algorithm (Alg₁, . . . , Alg_{N}) and allows third parties to obtain item recommendations (according to the engine or engines specified), items and users similarity, items preference indicators, related users, etc. Moreover, the data processor (850) module implements a wrapper engine using the API (890) for exchanging data with the pool of recommendation engines (860).

1. A method for providing content recommendations, comprising:
receiving, in a frontend server from a client application of a user,
a request of content items from different available sources,
and a set of explicit events, the set including
events based upon rating by the user using the client application of at least one content item
and additional events based upon explicit user actions within said client application;
generating, by the frontend server, an additional set of implicit events based upon additional user actions within said client application;
storing the explicit events and the implicit events in an online data store;
for each user in the frontend server, creating an explicit user model using all the explicit events and creating an implicit user model using all the implicit events;
sending all the explicit user models to a pool of recommendation engines (260, 860) comprising one or more recommendation algorithms, each recommendation algorithm assigning a ranked recommendation list of content items from each said requested source to the user as a result;
storing the results from the recommendation algorithms in the online data store;
aggregating the ranked recommendation lists assigned to the user, in accordance with a configuration of the pool of recommendation engines (260, 860) based on a user-dependent strategy, in order to obtain a plurality of content recommendations comprising ranked items; and
delivering a final arrangement of multiple content recommendation lists and information of the sources associated with each list in the final arrangement.

2. The method according to claim 1, wherein the final arrangement of multiple content recommendations is delivered by the frontend server in reply to the received request only if said final arrangement of multiple content recommendations is different from a previous arrangement of content recommendations stored in a cache of a user's device where the client application is running.

3. The method according to claim 2, wherein the frontend server pulls the final arrangement of multiple recommendation lists from the online data store

4. The method according to claim 3, wherein the frontend server requests the final arrangement of content recommendations to a data processor, in charge of obtaining the aggregation of the ranked recommendation lists assigned to the user and storing it in the online data store.

5. The method according to claim 4, wherein each recommendation algorithm applies preferences, comprising users' preferences and experts' preferences, to rank the content items within the recommendation list.

6. The method according to claim 5, wherein the explicit user model indicates stable preferences and the implicit user model indicates transient preferences.

7. The method according to claim 6, wherein the implicit user model applies computed weights to the preferences in the aggregation of the ranked recommendation lists.

8. The method according to claim 7, wherein the pool of recommendation engines is updated with the explicit user model created from the most recent stored explicit events and only the ranked items whose data sources have changed are updated.

9. The method according to claim 8, wherein the explicit user actions are content purchase or content reproduction and the additional user actions are navigation actions or information requests.

10. The method according to claim 9, wherein the pool of recommendation engines is based on, among others, collaborative filtering, collaborative filtering based on expert ratings, popularity, social recommendation, trust-based propagation and/or content-based recommendations.

11. The method according to claim 10, wherein the pool of recommendation engines comprises a single collaborative filtering algorithm for all users, a different algorithm for each user which is dynamically assigned to the user or a linear combination of multiple collaborative filtering algorithms.

12. The method according to claim 11, wherein the sources are a specific recommendation engine based on explicit events of the user, activity of any other user, activities of other users in a defined social graph related to the user or activity in external social networks.

13. The method according to claim 12, further comprising defining a size of the ranked recommendation lists, computing a diversity metric for each item in every list, updating an score for each item to add an scaled version of that diversity metric and reordered the items by the updated score within every list and applying the defined size of each list.

14. A system for providing content recommendations, wherein a request of content items from different available sources is received from a user, the system comprising:
a frontend server, which comprises one or more frontend managers, for receiving a set of explicit events from a client application of the user, the set of explicit events including
events based upon rating by the user using the client application of at least one of the content items
and additional events based upon explicit user actions within said client application,
and for generating an additional set of implicit events based upon additional user actions within said client application
a backend storage for storing data on events and users, which is connected to the frontend server;
an Online Data Store, connected to the frontend server, for storing the explicit events and the implicit events;
a Data Processor for creating an explicit user model using all the explicit events and creating an implicit user model using all the implicit events, and for storing the created explicit user model and the implicit user model in the Online Data Store, retrieving data on events and users from online data store and storing the retrieved data in the backend storage;
a pool of recommendation engines connected to the Online Data Store for receiving the explicit user model and comprising
one or more recommendation algorithms, each recommendation algorithm assigning a ranked recommendation list of content items to the user as a result,
and further comprising an aggregator controlled by the Data Processor for aggregating the ranked recommendation lists assigned to the user in accordance with a configuration of the pool of recommendation engines (260, 860) based on a user-dependent strategy, in order to obtain multiple content recommendations comprising ranked items, the content recommendations being delivered by the frontend server to the client application in a final arrangement which is pull from the Online Data Store along with data on the sources.

15. A digital data storage medium storing a computer program product comprising instructions causing a computer executing the program, to perform all steps of a method according to claim 1.
